(19) United States
(12) Patent Application Publication
(10) Pub. No.: US 2010/0163537 A1
(43) Pub. Date: Jul. 1, 2010

(54) APPARATUS AND METHOD FOR LASER MACHINING

(75) Inventors: Keisuke FURUTA, Tokyo (JP); Susumu Konno, Tokyo (JP); Masaki Seguchi, Tokyo (JP); Junichi Nishimae, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Mitsubishi Electric Corporation, Tokyo (JP)

(21) Appl. No.: 12/594,733

(22) PCT Filed: Apr. 4, 2008
(86) PCT No.: PCT/JP2008/056773

§ 371 Date: Oct. 5, 2009

(30) Foreign Application Priority Data
Apr. 4, 2007 (JP) 2007-097905
Apr. 4, 2007 (JP) 2007-097906

(51) Int. Cl. B23K 26/00

(52) U.S. Cl. 219/121.72

(57) ABSTRACT

A laser machining device includes a laser oscillator, a laser machining head, an optical fiber transmitting the laser beam oscillated by the laser oscillator to the laser machining head, and an assist gas supply supplying an assist gas of oxygen to the laser machining head. The optical fiber includes a remover removing a clad transmitting beam or reducer for reducing the beam. The laser beam leaked from the core of the optical fiber into the clad is absorbed by a beam absorber at the remover. The structure ensures a high quality surface with no irregularity on the metal surface cut by the laser beam projected from the machining head.

### FIELD OF THE INVENTION

The present invention relates to a laser machining apparatus and method for machining works, e.g., metal plates, by using laser beam transmitted from an optical fiber.

### BACKGROUND OF THE INVENTION

The optical fibers have been used as laser transmitting means of the laser machining apparatus. Typically, the optical fiber has a central core and a clad disposed around the core. The core is made of, for example, quartz or transparent plastic. Also, the core is made of material with a certain refraction index larger than that of the clad in order to confine the beam within the core. Practically, however, the beam is not confined completely within the core and, unavoidably, a small amount of beam may leak from the core into the clad. To remove the leaked beam from the clad, JP 2003-139996 A proposes to mount a beam removing member around the clad. Also proposed in U.S. Pat. No. 4,575,181 is to rough a part of the outer peripheral surface of the clad for allowing the leaked beam in the clad to emit from the clad therethrough. These techniques, however, can not remove the leaked beam completely or substantially completely, which allows a small amount of light to be projected through the clad against the works. It has been understood that the amount of beam to be projected against the work is so small that it does not provide a significant affect to the laser machining accuracy. However, the experiments conducted by the inventors revealed that, when cutting the metal plate by using the fiber-laser in which the laser is generated in the active fiber, the small amount of clad transmitting laser caused small irregularities on the cut surface.

Accordingly, an object of the present invention is to provide an apparatus and a method for laser machining which prevent the unwanted clad transmitting laser effectively.

### SUMMARY OF THE INVENTION

According to the invention, a laser beam is transmitted through an optical fiber with a core and a clad and projected to works for the machining thereof while providing an assist gas of oxygen to the work. During the machining, the beam transmitting in the clad of the fiber is removed or reduced at a removing and/or reducing portion.

With the arrangement, a high quality cutting surface with less irregularities is attained on the cut surface in the metal works.

### BRIEF DESCRIPTION OF THE DRAWINGS

FIG. 1 is a schematic view showing a structure of a laser machining apparatus of the first embodiment according to the invention.

FIG. 2 is a cross sectional view showing a structure of a remover made of absorbing member.

FIG. 3 is a cross sectional view showing a structure of a remover made of transmitting member.

FIG. 4 is a schematic view showing a second embodiment of the laser machining device according to the invention.

FIG. 5 is a schematic view showing a third embodiment of the laser machining device according to the invention.

FIG. 6 is a schematic view showing a fourth embodiment of the laser machining device according to the invention.

FIG. 7 is a schematic view showing a fifth embodiment of the laser machining device according to the invention.

FIG. 8 is a graph showing a relationship between a ratio of strength of a clad transmitting beam to a core transmitting beam and a roughness of the cut surface.

FIG. 9 is a longitudinal cross sectional view of the machining head.

FIG. 10 is a diagram showing a transmission path of the beam within the machining head.

FIG. 11 is a diagram showing a profile of beam projected from a machining head without an aperture plate.

FIG. 12 is a diagram showing a profile of beam projected from a machining head without an aperture plate.

FIG. 13 is a diagram showing a profile of beam projected from a machining head with the aperture plate.

FIG. 14 is a diagram showing a part of a fiber laser device including the optical fiber device and the optical fiber device.

FIG. 15 is a cross sectional view showing a part of the optical fiber and the optical fiber device according to the seventh embodiment of the invention.

FIG. 16 is a cross sectional view showing a part of the optical fiber and the optical fiber device according to the seventh embodiment of the invention.

FIG. 17 shows a diagram showing a structure of the device for determining a power ratio of the clad transmitting beam to the core transmitting beam.

FIG. 18 is an end view of the optical fiber.

FIG. 19 is a diagram showing a relationship between an image projected on a transfer surface and a knife-edge.

FIG. 20 is a graph showing a relationship between the position of the knife-edge and the optical power transmitted on the transfer surface.

### DETAILED DESCRIPTION OF THE PREFERRED EMBODIMENTS

Referring to the accompanying drawings, several preferred embodiments of the present invention will be described below. Like reference numerals designate like parts throughout the embodiments.

### First Embodiment

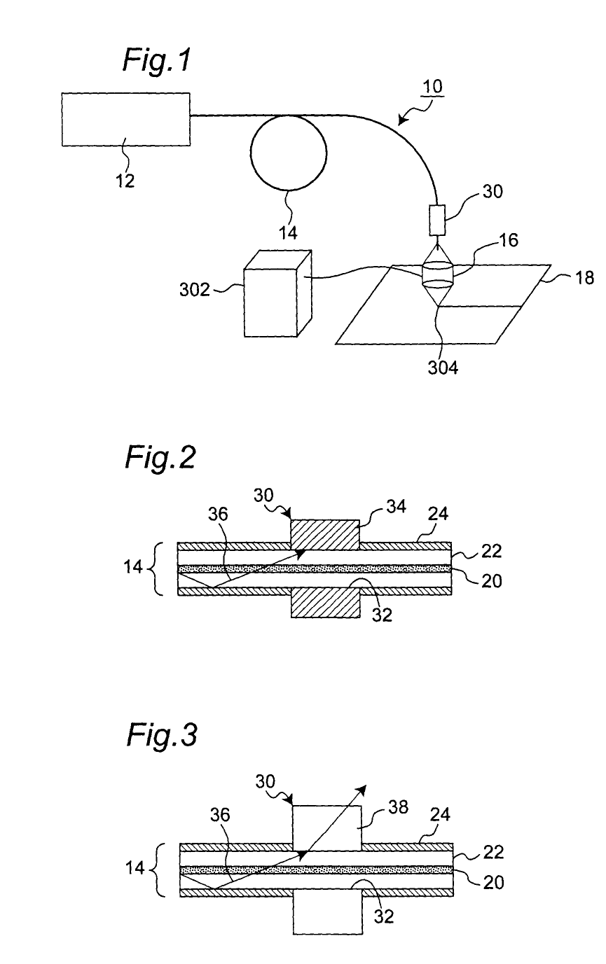

FIG. 1 shows an embodiment of the laser machining device according to the invention. As illustrated in the drawing, the laser machining device 10 has a laser oscillating unit made of laser oscillator 12 which generates a laser beam having a wavelength and power suitable for metal working. An optical transmitter made of an optical fiber 14 is connected at its one end to the output of the laser oscillator 12. As shown in FIG. 2, the optical fiber 14, which is suitable for transmitting the laser beam generated from the laser oscillator 12, has a central core 20 and a clad 22 disposed around the core 20. The core 20 and the clad 22 are made of respective materials with high optical transmittances, such as quartz glass and plastic. In particular, the refractive index of the core 20 is greater than that of the clad 22. A jacket 24, made of suitable material such as silicone resin, is disposed around the clad to ensure a certain strength required for the optical fiber 14.

Referring back to FIG. 1, the other end of the optical fiber 14 is connected to a laser emitting head or machining head 16. The machining head 16 cooperates with the optical fiber 14 to form a beam transmitting section of the invention. Preferably, the machining head 16 is held by a fixed or movable holder not shown so that the laser emitting port not shown is positioned adjacent the work 18 such as a metal plate. The laser machining device 10 further has an assist gas supply 302 so that the assist gas (oxygen) is supplied from the assist gas supply 302 and then ejected through an assist gas nozzle (not shown) provided adjacent the laser emitting port toward a laser machining position 304 to be positioned adjacent the laser emitting port. Alternatively, the laser emitting port may also be used for the assist gas nozzle.

In the first embodiment, the optical fiber 14 has a beam remover 30 adjacent the machining head 16 for removing the leaked beam in the clad 22 therethrough. As shown in FIG. 2, the beam remover 30 has a clad-exposed surface 32 formed by removing a part of the outermost jacket 24 of the optical fiber 14 peripherally and continuously and an absorbing member 34 covering the clad-exposed surface 32. The absorbing member 34 is made of material having an increased optical absorptance, such as an increased heat conductive material of copper or aluminum with black coating, for example. Preferably, the exposed surface 32 is so designed that the beam 36 leaked from the core 20 into the clad 22 is substantially transmitted therethrough into the absorbing member 34, rather than being reflected thereat back into the interior of the clad 22. For this purpose, the clad-exposed surface 32 is in contact with the absorbing member 34 through a certain liquid such as refraction matching oil having a refraction index equivalent to or greater than that of the clad 22.

As shown in FIG. 3, a light transmitting member 38 may be used, instead of the light absorbing member 34, for transmitting the light 36 through the clad-exposed surface 32 in the radial and outward directions. Preferably, as shown in the drawing, the light transmitting member 38 is made of material having a greater refraction index than the clad 22. More preferably, the clad 22 and the light transmitting member 38 are bonded to each other by using an optical coupling adhesive in order to improve the light coupling between the clad 22 and the light transmitting member 38 through the clad-exposed surface 32.

With the laser machining device 10 so constructed, the laser beam generated from the laser oscillator 12 is transmitted through the optical fiber 14 to the machining head 16 from which it is projected onto the work 18. The beam 36 leaked from the core 12 into the clad in the optical fiber 14 is absorbed by the absorbing member 34 of the beam remover 30 as shown in FIG. 2 or discharged through the light transmitting member 38 into the atmosphere as shown in FIG. 3.

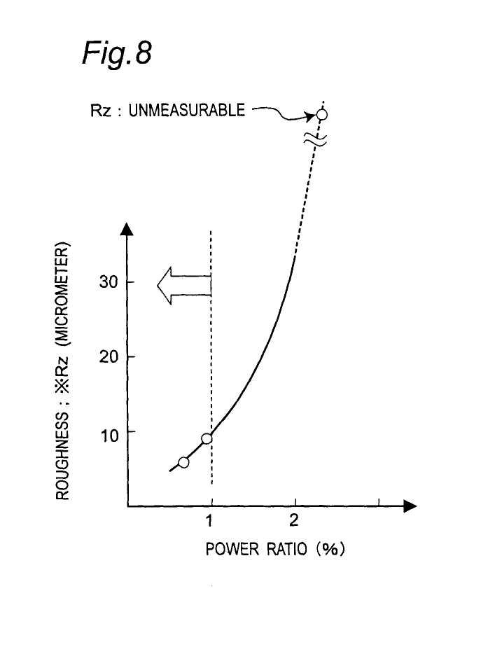

FIG. 8 shows a test result in which mild steel plates were cut by the device while changing the ratio of the power of beam transmitted through the clad 22 to the optical power of the beam transmitted through the core 20 (hereinafter referred to as “power ratio”) and the roughness was measured on the cut surfaces. As can be seen from the drawing, the roughness Rz at the power ratio of 2.5% was unmeasurable. When the power ratio was 1%, the roughness was 10 μm or less and a significantly high quality smoothed surface was obtained. In the test where the power of laser beam transmitting in the clad was set 2 kW, a high quality cutting was ensured by setting the power of laser beam transmitting the clad 20W or less. Although the mild steel was used for the works in the test, any materials capable of being cut by the burning reaction using oxygen, such as other steels, may be used for the works.

As discussed above, the inventors have first revealed that the cutting quality was drastically increased by reducing the beam transmitting the clad of the optical fiber in the cutting operation using laser beam being transmitted through the optical fiber. Conventionally, it has been known in the art that, in the cutting of the mild steel plate by using CO₂ laser in which the laser beam from the oscillator is transmitted in the air and then concentrated for cutting due to the fact that its wavelength is about 10 μm and therefore it is unable to be used with the optical fibers, the weak beam portion existing around the main beam portion provides an adverse affect on the cutting quality. It has also been known that, in the CO₂ laser cutting of the mild steel in which the burning reaction of oxygen may affect the cutting quality, a threshold of energy density necessary for the conventional mild steel or iron to be machined is considered to be about 50 kW/cm². Typically, the energy density of the laser beam at the cutting position or focusing point is set to be 10 MW/cm² or more. In contrast, the threshold is considerably low. Therefore, it is considered that only a small amount of energy around the main beam portion may provide an adverse affect on the cutting quality. In the cutting of stainless steel in which nitrogen is used for the assist gas so that no burning reaction would occur between the assist gas and the work to be machined, the threshold of energy density is considerably high, i.e, 1 MW/cm², so that the weak beam portion around the main beam portion may not provide a significant affect on the cutting quality.

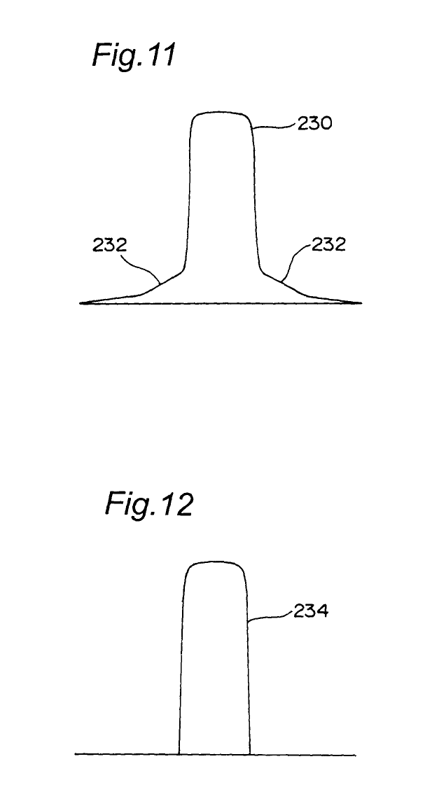

The laser beam generated by YAG laser or fiber laser has a wavelength of 1 μm which is about one tenth of that generated by the CO₂ laser and therefore it can be transmitted by the use of optical fiber. Typically, as described with reference to FIG. 1, the beam from the laser oscillator is introduced into and transmitted by the fiber and then ejected from the output port of the fiber to machine the work as if the output port is transferred onto the work. The inventors of the invention found that the laser beam energy emitted from the output port and transferred on the work distributes as indicated FIG. 11. The inventors also found that lower-energy side portions extending around the higher-energy main portion is provided from the laser beam component which is transmitted from the clad. Conventionally, it has not been understood in the art that how much of the laser beam energy is transmitted through the clad. Also, it has not been known that the laser beam being transmitted through the clad would affect the machining of the work. The inventors of the invention considered that the laser beam transmitted through the clad would affect the machining as the weak energy portion existing around the main portion of CO₂ laser. The inventors thought that the machining quality for the mild steel or other irons would be improved by reducing the laser beam transmitting through the clad to obtain an energy distribution shown in FIG. 12 and, based on this, conducted a test using a laser with the energy distribution as shown in FIG. 12. As a result, expected results were obtained. The inventors conducted another test which revealed that, in the cutting of stainless steel using nitrogen as assist gas, no significant difference was confirmed in the cutting quality irrespective of whether the clad transmitting laser was removed or not. Also, when melting the work such as welding in which the laser beam is used for melting the work, it can be thought that the weak energy transmitting through the clad does not provide a significant affect on the machining quality.

A machining threshold of energy density for cutting the mild steel or other irons using laser with a wavelength of about 1 μm is considered to be 50 kW/cm² which is equivalent to that using CO₂ laser or less than 50 kW/cm² because the absorption rate by those materials for the laser with the wavelength of about 1 μm is higher than that for CO₂ laser. In order to improve the cutting quality, among other things, the laser energy density of the laser beam transmitted through the clad and transferred on the work should be equal to or less than the machining threshold. For this purpose, when cutting the mild steel or other irons, the energy density of the laser beam is preferably equal to or less than 50 kW/cm², more preferably equal to or less than 30 kwa/cm².

In the actual test result shown in FIG. 8, the reduced total energy of the laser beam transmitting through the clad (clad transmitting power) was 20W, corresponding to about 15 kW/cm² in energy density on the work. This means that the density of laser to be transmitted through the clad and then transferred on the work is preferably equal to or less than 15 kW/cm².

The energy density of the laser at the machining portion can be calculated. For example, since the output port of the fiber is transferred on the machining point, a combined diameter of core and clad portions, transferred on the machining point, is measured by using Focus Monitor, commercially available from PRIMES GmbH in German. The distribution of the laser beam from the clad is supposed to be substantially uniform at the output of the fiber and therefore the energy density of the laser beam portion transmitted from the clad can be determined from the following equation:

E=W{π(Rc²−Rs²}

wherein E is energy density, Rc is a radius of core, and Rc is an outer radius of the clad.

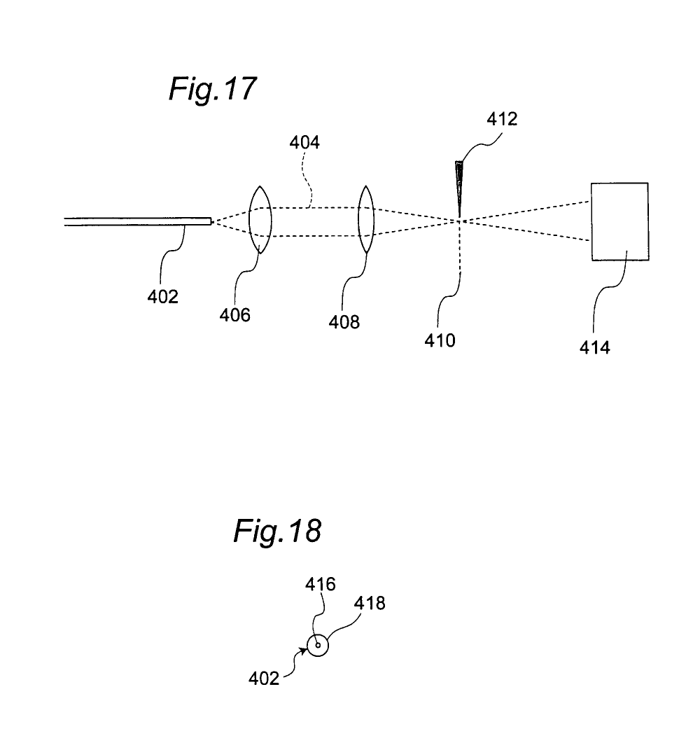

Referring to FIG. 17, discussions will be made to a process for determining the power ratio. As shown in the drawing, the laser beam 404 emitted from the output port 402 of the fiber is collimated by the collimator 406. The collimated laser beam 404 is then collected by the collecting lens 408 onto the transfer surface 410. Preferably, the collimator lens 406 and the collecting lens 408 with minimum aberration are used. For this purpose, each of the collimator lens 406 and the collecting lens 408 is made by a combination of plural lenses. If the focal lengths of the collimator lens 406 and the collecting lens 408 are f1 and f2, respectively, the image projected from the fiber output port is focused on the transfer surface 410 at f2/f1-fold magnification. The image on the transfer surface 410 is cut off in part by a knife-edge 412 disposed vertically against the optical axis. The optical power of the remaining beam without being cut off by the knife-edge 412 is measures by the power meter 414.

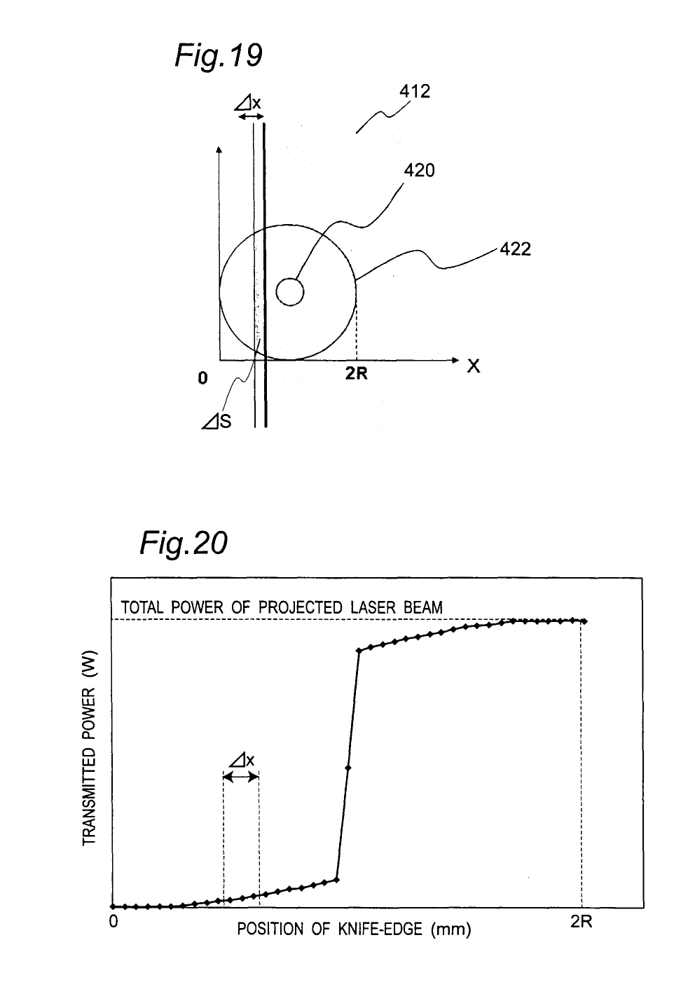

FIG. 18 shows an end elevational view of the optical fiber 402. FIG. 19 shows images transferred on the transfer surface 401 from the optical fiber 402, in which the reference numeral 420 indicates the image formed by the beam emitted from the core 416 of the fiber and the reference numeral 422 indicates the image formed by the beam emitted from the clad. In FIG. 19, the shaded portion is the area in which the beam is cut off by the knife-edge 412.

FIG. 20 shows a relationship between the movement (x) or the position of the knife-edge 412 and the light power (W) measured by the power meter 414 when the knife-edge 412 is moved from one end to the opposite end of the image 422 (left end to right end of the image in FIG. 19; x=0 to 2 R). In FIG. 20, the power increase in the fragment indicated by Δx is associated with the fragmentary area increase indicated by ΔS. When assumed that the uniform light is emitted from the entire area of the clad, the power increase in the fragmentary area ΔS can be determined by differentiating light power in the fragment Δx and also the total power from the entire area of the clad can be determined using the relationship between the respective fragmentary areas ΔS and their power increases.

According to this technique, the ratio of power transmitting in the clad can be determined precisely. For example, if the focal length f1 of the collimator lens 406 is 20 mm and the focal length f2 of the collecting lens 408 is 150 mm, the transfer magnification is 7.5. Then, for the single-mode optical fiber with a clad diameter of 125 μm, the optical image emitted from the clad has a diameter of 900 μm on the transfer point, which is sufficient for measuring the optical power and the power ratio of the beam transmitting in the clad.

It is noted that the energy density distribution of the collected laser beam can be measured by FocusMonitor commercially available from PRIMES GmbH in Germany. Using the measurement, the energy, the ratio, and the energy density of the beam transmitting in the clad can be determined.

### Second Embodiment

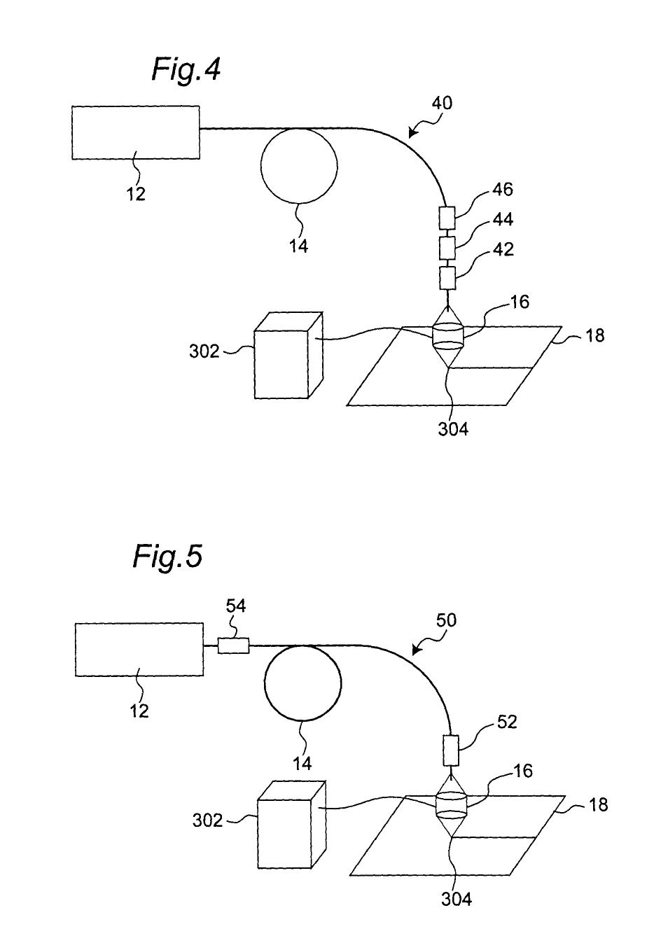

FIG. 4 shows another laser machining device 40 according to the second embodiment of the invention. The laser machining device 40 has a plurality of leaked-beam removers 42, 44, and 46 provided adjacent the machining head 16. Each remover may be any one of the structures shown in FIGS. 2 and 3. The structure in FIG. 2 is employed for one remover and the structure in FIG. 3 is used for another removers.

According to the laser machining device 40 with plural beam removers, the removing efficiency of each beam remover can be reduced while ensuring the necessary removability in total. This reduces the heat increase in the absorbing member 34. Also, the optical power from the transmitting member 38 can be controlled easily. Further, even if the optical power of the beam transmitting in the clad is large, the substantial part of the entire power of the beam can be removed while reducing the load of each remover. As above, this arrangement restricts the optical power of the beam transmitting in the clad. Consequently, the energy density of the beam emitted from the clad onto the machining point is reduced to equal to or less than 50 kW/cm², preferably equal to or less than 30 kW/cm², more preferably equal to or less than 15 kW/cm², which ensures a high quality smoothness with only minimum roughness Rz in the metal surface cut by the laser from the machining head.

### Third Embodiment

FIG. 5 shows another laser machining device 50 according to the third embodiment of the invention. The machining device 50 has optical removers 52 and 54 provided at one end portion of the optical fiber, adjacent the machining head 16, and the other end portion thereof, adjacent the laser oscillator 12. Each remover may be any one of the structures shown in FIGS. 2 and 3. The structure in FIG. 2 is employed for one remover and the structure in FIG. 3 is used for another removers.

According to the laser machining device 50 with the removers 52 and 54 on opposite ends of the optical fiber 14, the laser beam leaked into the clad at the end of the optical fiber 14, connected to the laser oscillator 12, can be removed immediately after the leakage of the beam into the clad. This prevents the heat generation and/or the resultant damages caused thereby on the clad 22 due to the beam leaked in the clad and reduces the load of the other remover 52. Also, the substantially the entire part of the clad transmitting beam can be removed through the removers 52 and 54. As above, this arrangement restricts the optical power of the beam transmitting in the clad. Consequently, the energy density of the beam emitted from the clad onto the machining point is reduced to equal to or less than 50 kW/cm², preferably equal to or less than 30 kW/cm², more preferably equal to or less than 15 kW/cm², which ensures a high quality smoothness with only minimum roughness Rz in the metal cutting surface cut by the laser emitted from the machining head.

### Fourth Embodiment

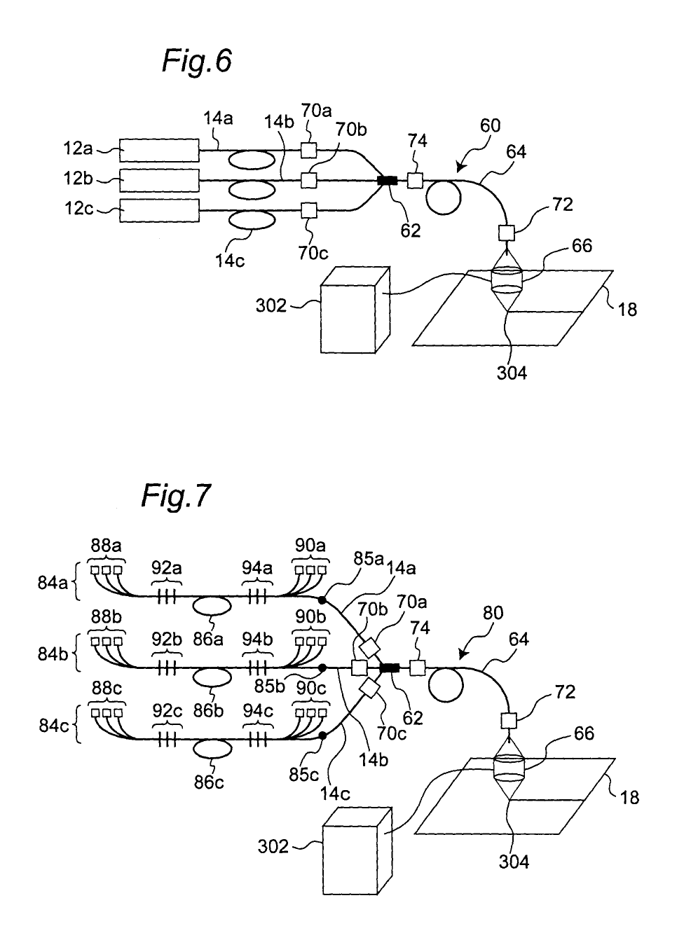

FIG. 6 shows another laser machining device according to the fourth embodiment of the invention. As shown in the drawing, the laser unit 12 of the laser machining device 60 has three laser oscillators 12a, 12b, and 12c. In this embodiment, the number of the laser oscillators is not restrictive and two or more laser oscillators may be provided. The output ports of the laser oscillators 12a, 12b, and 12c are connected to the one ends of the optical fibers 14a, 14b, and 14c, respectively. The longitudinal cross section of the optical fibers 14a, 14b, and 14c are the same as that indicated in FIGS. 2 and 3. The other ends of the optical fibers 14a, 14b, and 14c are connected to a fiber bundle 62 which in turn connected to another optical fiber 64 so that the optical fibers 14a, 14b, and 14c are optically connected at the fiber bundle 62 to the optical fiber 64. The other end of the optical fiber 64 is connected to a laser emitting head or machining head 66. The machining head 66 is held by an immovable or movable holder not shown so that the laser emitting port is positioned adjacent the work 68 such as metal plate. As described above, according to the fourth embodiment, the beam transmitting section connecting the oscillators 12a, 12b, and 12c and the laser machining head 66 is made of optical fibers 14a, 14b, and 14c and the fiber bundle 62.

Also in the fourth embodiment, the optical fibers 14a, 14b, and 14 have removers 70a, 70b, and 70c mounted thereon, respectively. Each of the removers 70a, 70b, and 70c may be any one of the structures shown in FIGS. 2 and 3. The removers 70a, 70b, and 70c may be provided on respective portions of the optical fibers 14a, 14b, and 14c, adjacent the laser oscillators 12a, 12b, and 12c, respectively, or adjacent the fiber bundle 62.

Although each of the optical fibers 14a, 14b, and 14 has one remover in this embodiment, it may has one or more removers at respective portions adjacent the laser oscillator and the fiber bundle.

Also, although the removers 72 and 74 are provided on opposite ends of the optical fiber 64 connecting between the fiber bundle 62 and the machining head 66, it is not necessary to provide the remover on opposite ends of the optical fiber and may be provided on one end of the optical fiber.

In addition, a plurality of removers may be provided on one or the other end of the optical fiber 64.

According to the laser machining device 60 so constructed, the laser beams from the laser oscillators 12a, 12b, and 12c are transmitted through the optical fibers 14a, 14b, and 14c, respectively, into the fiber bundle 62 where they are combined with each other. The combined beam is then transmitted through the optical fiber 64 to the machining head 66 from which it is projected to the work 68. The laser beams leaked into the clad from the core or directly transmitted into the clad of the optical fibers 14a, 14b, and 14c are removed at the removers 70a, 70b, and 70c. Also, the laser beam leaked into the clad from the core or directly transmitted into the clad of the optical fiber 64 is removed at the removers 72 and 74.

As described above, the laser machining device according to the fourth embodiment of the invention ensures that the beam to be transmitted through the clad into the fiber bundle 62 is reduced or eliminated. This restricts the heat generation at the fiber bundle 62 due to the beam transmitting in the clad, which increases the reliability of the fiber bundle 62. Also, since the remover 72 is provided on the optical fiber 64 transmitting the combined laser beam, in particular at a portion adjacent the fiber bundle 62, the beam leaked at the portion where the optical fiber is fused and connected to the fiber bundle 62 is removed therefrom immediately after the leakage. This prevents the heat generation and/or the resultant damages due to the beam transmitting in the clad and also reduces the load of the remover 74 provided adjacent the machining head 66. As described above, the substantially part of the clad transmitting beam can be removed at the removers 72 and 74, which reduces the optical power of the beam transmitting in the clad. Consequently, the energy density of the beam emitted from the clad onto the machining point is reduced to equal to or less than 50 kW/cm², preferably equal to or less than 30 kW/cm², more preferably equal to or less than 15 kW/cm², which ensures a high quality smoothness with only minimum roughness Rz in the metal cutting surface cut by the laser emitted from the machining head.

Although the optical fibers 14a, 14b, and 14c are fused and optically connected at the fiber bundle 62, they may be optically connected to the optical fiber 64 by using optical member such as lens.

### Fifth Embodiment

FIG. 7 shows another laser machining device 80 according to the fifth embodiment of the invention. In the laser machining device 80, the laser oscillators are made of fiber laser oscillators 84a, 84b, and 84c, respectively, each manufactured using an active optical fiber in which rare-earth element is doped in its fiber core. The fiber laser oscillators 84a, 84b, and 84c have active optical fibers 86a, 86b, and 86c connected to optical fibers 14a, 14b, and 14c through connecting portions or fused portions 85a, 85b, and 85c, respectively. The active optical fibers 86a, 86b, and 86c are connected to one exciting light sources 88a, 88b, and 88c and the other exciting light sources 90a, 90b, and 90c, respectively. The cores of the optical fibers 14a, 14, and 14c extending between the exciting light sources 88a, 88b, and 88c and 90a, 90b, and 90c have two fiber bragg gratings 92a, 92b, and 92c and 94a, 94b, and 94c formed therein, respectively. According to the laser machining device 80, the beams transmitted from the exciting light sources 88a, 88b, and 88c and 90a, 90b, and 90c are excited between the fiber bragg gratings 92a, 92b, and 92c and 94a, 94b, and 94c, respectively. Then, the excited beams are transmitted into the optical fibers 14a, 14b, and 14c, respectively.

As described above, the laser machining device 80 according to the fourth embodiment of the invention reduces or eliminates the beam to be transmitted through the clad into the fiber bundle 62

As described above, the laser machining device 80 according to the fifth embodiment of the invention ensures that the beam to be transmitted through the clad into the fiber bundle 62 is reduced or eliminated by the removers 70a, 70b, and 70c provided adjacent the fiber bundle 62. This restricts the heat generation at the fiber bundle 62 due to the beam transmitting in the clad, which increases the reliability of the fiber bundle 62. Also, since the remover is provided on the optical fiber 64 transmitting the combined laser beam, in particular at a portion adjacent the fiber bundle 62, the beam leaked at the portion where the optical fiber is fused and connected to the fiber bundle 62 is removed therefrom immediately after the leakage. This prevents the heat generation and/or the resultant damages due to the beam transmitting in the clad and also reduces the load of the remover 74 provided adjacent the machining head 66. As described above, the substantially part of the clad transmitting beam can be removed at the removers 72 and 74, which reduces the optical power of the beam transmitting in the clad. Consequently, the energy density of the beam emitted from the clad onto the machining point is reduced to equal to or less than 50 kW/cm², preferably equal to or less than 30 kW/cm², more preferably equal to or less than 15 kW/cm², which ensures a high quality smoothness with only minimum roughness Rz in the metal cutting surface cut by the laser emitted from the machining head.

### Sixth Embodiment

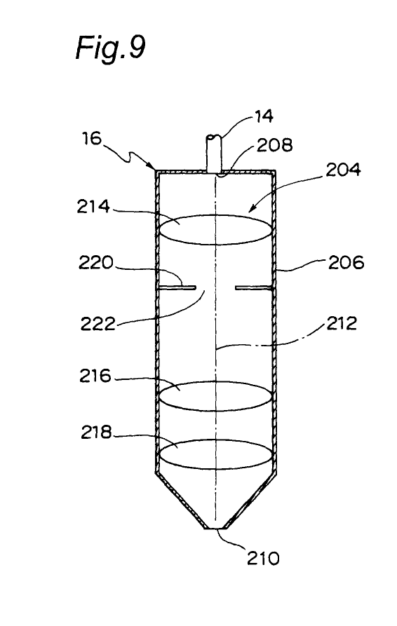

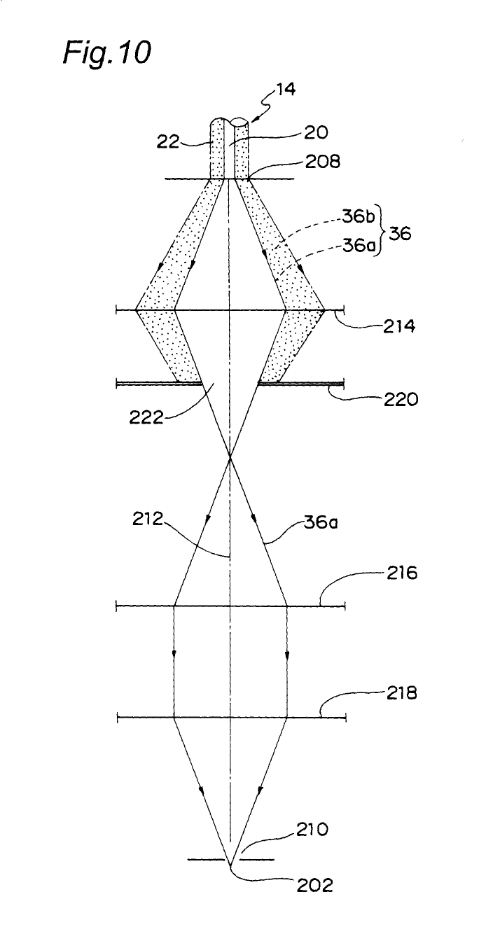

FIG. 9 shows the machining head 16. The head has an optical system 204 for guiding the beam from the output port of the optical fiber 14 to the machining point 202 and a housing 206 for accommodating the optical system 204. The housing 206 has an input port 208 and an output port to be disposed adjacent the machining point 202. The optical system 204 has a plurality of optical lenses for guiding the beam input from the input port 208 into the interior of the housing, along an optical axis 212. In this embodiment, the optical system 204 has a first 214, a second 216, and a third 218, in this order from the input port 208 toward the output port 210. The optical system 204 further has an aperture plate 220 provided between the first and the second lenses, 214 and 216, to shape the cross section of the laser beam 36 advancing toward the machining point 202 into a predetermined form. For this purpose, the aperture plate 220 has a circular aperture 222 with its center positioned on the optical axis 212. As shown in FIG. 10, the size of the aperture 222 is so determined that the aperture plate 220 transmits the beam component 35a only from the core 20 and cuts off the beam component 36b from the clad 22, of the beam 36 projected from the optical fiber 14 and then transmitted through the lens 214.

According to the machining head 16 so constructed, the beam 36 including beam components 36a and 36b, emitted from the optical fiber 14, is collected by the first lens 214. The beam component 36a from the core 20 of the collected beam 36 is transmitted through the aperture 222 of the aperture plate 220 into the second lens 214. The beam component 36b from the clad 22, on the other hand, is cut off by the aperture plate 220. This results in that only the beam component 36a from the clad 22 is transformed into a parallel beam by the second lens 216 and then collected again by the third lens 218 onto the machining point 202 through the output port 210.

Therefore, according to the machining head 16 of the embodiment, the beam component 36b from the clad does not illuminate and heat the housing portion defining the output port 210 to transform it. This ensures that the beam with a predetermined, constant shape is projected to the work to prevent the machining accuracy from being damaged, which would otherwise be caused by the thermally-deformed housing.

If no aperture plate exists in the machining head, the beam from the head includes the beam component from the clad as shown in FIG. 11 and then the beam profile 230 at the machining point provides an energy distribution in the Gaussian form which includes the side weak portions where the energy changes gently, which fails to ensure a high precision on the machined surface. In contrast, according to the machining head 16 of the embodiment, as shown in FIG. 12 the beam profile 234 at the machining point provides a flat top with no side portions, which ensures a high precision on the machined surface.

Although the aperture plate is disposed between the first and the second lenses in the embodiment, the position is not restrictive. Also, the shape of the aperture is not limited to the circle and it may take any configurations. Ideally, it is preferable to remove the entire beam component from the clad by the aperture plate, however, the removing rate is not needed to be 100%.

According to the embodiment, the beam power from the clad is restricted. Consequently, the energy density of the beam emitted from the clad onto the machining point is reduced to equal to or less than 50 kW/cm², preferably equal to or less than 30 kW/cm², more preferably equal to or less than 15 kW/cm², which ensures a high quality smoothness with only minimum roughness Rz in the metal cutting surface cut by the laser emitted from the machining head.

### Seventh Embodiment

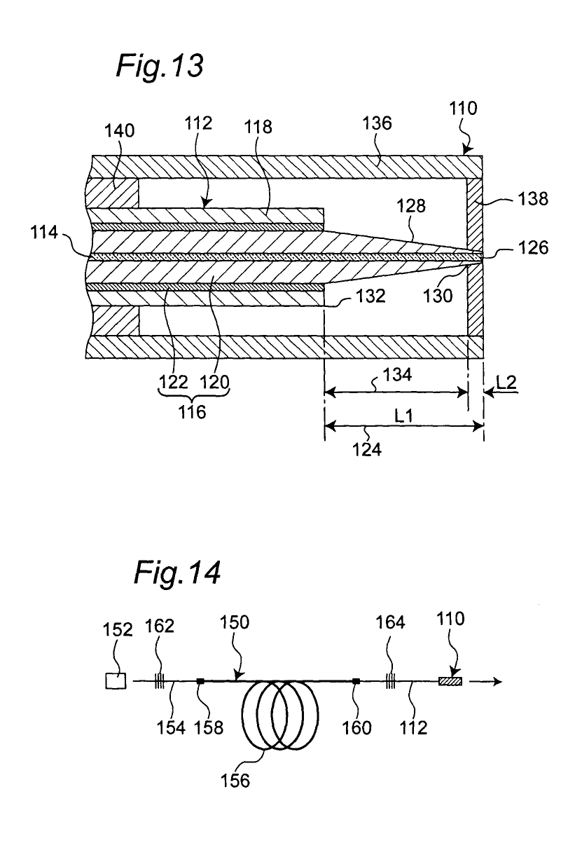

FIG. 13 shows an optical fiber of the invention and a optical fiber device with the optical fiber for transmitting a laser beam for machining according to the invention. As shown, the optical fiber device 110 has an optical fiber 112 for guiding a laser beam. A wavelength of the laser beam to be guided by the optical fiber 112 is not restrictive. The optical fiber 112 has a core 114 with a certain diameter, a clad 116 disposed around the core 114, and a jacket disposed around the clad 116. In this embodiment, the optical fiber 112 is indicated as a double-clad multimode step-index fiber. The clad 116 has an inner first clad 120 and an outer second clad 122. Typically, in the double-clad fiber for transmitting a multimode high-power laser beam, the diameter of the core 114 (for example, 20 μm) is larger than the diameter (about 10 μm) of the single-mode optical fiber for communication. Also, for example, the outer diameter of the first clad 120 is about 400 μm and the outer diameter of the second clad 122 is about 500 μm.

The distal end of the optical fiber 112, i.e., the right end in the drawing, has an exposed portion 128 of the first clad 120 which is formed by removing a part of the second clad 122 and a part of the jacket 128 within a region 124 which extends back a certain distance L1 from the output end 126 of the core 114. The exposed portion 128 of the first clad 120 within the region 124 is continuously tapered toward the distal end of the clad. The taper is provided by dipping the optical fiber in hydrofluoric acid to dissolve the glass-clad in part, which ensures a smooth outer peripheral surface on the taper. The distal end of the optical fiber 112 including the exposed portion 128 is mounted in a sleeve 136 so that the optical fiber 112 stays out of contact with the sleeve 136. The sleeve 136 retains the optical fiber 112 by a first annular retainer 138 disposed around the distal end of the core 114 and a second annular retainer 140 disposed around the jacket 118. Preferably, the sleeve 136 and the first retainer 138 are made of material such as metal which provides a high absorption rate to the laser beam so as to prevent the laser beam to be emitted from the clad from leaking out into the atmosphere.

FIG. 14 shows a fiber laser device 150 which includes the optical fiber device in FIG. 13. The fiber laser device 150 has an exciting light source 152. The exciting light source 152 is connected through a light guide 154 to an active fiber 156 so as to excite the active fiber 156 doped with rare-earth element. The active fiber 156 has opposed fiber bragg gratings 162 and 164 to oscillate a laser beam which is emitted from the output end 126 of the optical fiber 112. In the embodiment, the light guide 154 and the active fiber 156 are optically coupled with each other by fusing, for example. The active fiber 156 and the optical fiber 112 are also optically coupled with each other by fusing, for example.

According to the fiber laser device 150 so constructed, the laser beam excited between the opposed fiber bragg gratings 162 and 164 is transmitted into the core 114 of the optical fiber 112 and then projected from the output end 126 of the core against the work. Since the tapered exposed portion 128 has a reduced allowable NA, the exciting laser beam introduced in the clad or the leaked laser beam from the core 114 are scattered radially outwardly from the exposed portion 128. The scattered laser beam is absorbed in the sleeve 136 spaced away from the optical fiber 112 and/or first retainer 138 where it is heat-dissipated. Also, the distal end of the clad disposed around the core is so small in size that no or, if any, only a small amount of laser beam reflected at the work is introduced into the clad.

As described above, since the distal end of the clad in the distal end portion of the optical fiber 112 is continuously tapered toward the output end of the core, the laser beam transmitting in the clad is reliably discharged and then absorbed in the sleeve disposed and spaced around the optical fiber. Therefore, the laser beam transmitting in the clad is reliably removed from the optical fiber and the optical fiber device and fiber laser device with the optical fiber. Also, the laser beam reflected at the work is substantially or completely prohibited from entering into the clad. Further, the tapered external surface of the clad is so smoothed that no substantial deterioration of strength occurs in the optical fiber. Furthermore, the taper of the clad exposed portion 128 is machined in a relatively easy way, which allows the optical fiber, the optical fiber device, and the fiber laser device to be manufactured economically.

### Eighth Embodiment

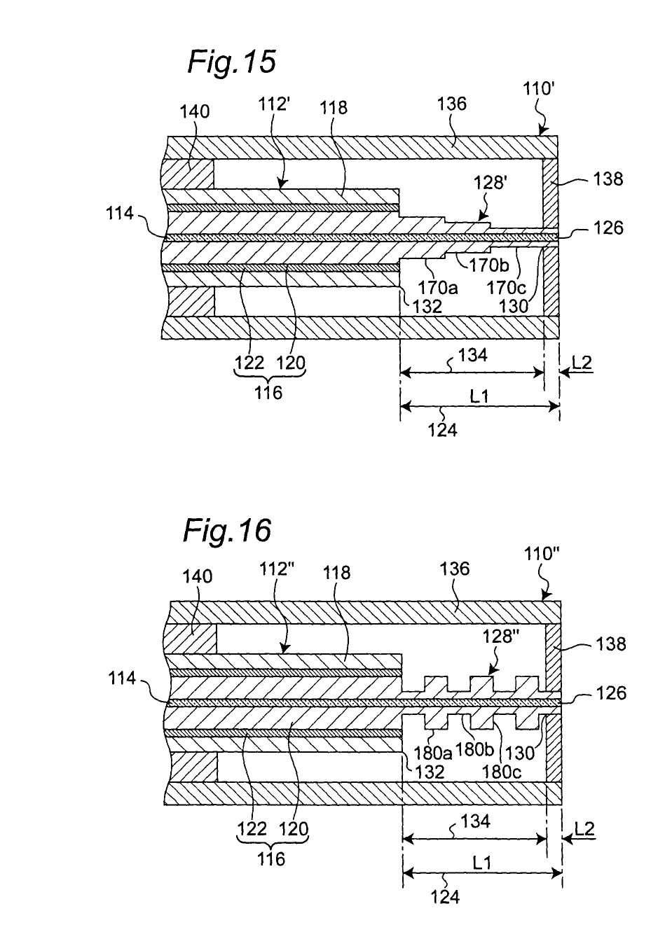

FIG. 15 shows another optical fiber and another optical fiber device which incorporates the optical fiber. As shown, in the optical fiber device 110′, the optical fiber 112′ has an exposed portion 128′ which is different in shape from the exposed portion 128 of the optical fiber 112. For example, in this embodiment, the exposed portion 128 has a plurality of steps or reduced diameter portions 170a-170c having smaller outer diameters toward the distal end thereof. The steps are formed by dipping the optical fiber in hydrofluoric acid to dissolve the glass-clad in part, which ensures smooth outer peripheral surfaces.

According to the embodiment, the laser beam introduced and/leaked in the clad 20 is removed from the clad at each boundary portions between the enlarged and reduced portions and depending upon the reduction rate of the cross section. The removed laser beam is then heat-absorbed by the sleeve 136 and the first retainer 138. Also, the distal end of the clad disposed around the core is so small in size that no or, if any, only a small amount of laser beam reflected at the work is introduced into the clad. Therefore, the laser beam transmitting in the clad is reliably removed from the optical fiber. Further, the tapered external surface of the clad is so smoothed that no substantial deterioration of strength occurs in the optical fiber. Furthermore, the taper of the clad exposed portion 128 is machined in a relatively easy way, which allows the optical fiber, the optical fiber device, and the fiber laser device to be manufactured economically.

### Ninth Embodiment

FIG. 16 shows another optical fiber and another optical fiber device which incorporates the optical fiber. As shown, in the optical fiber device 110″, the optical fiber 112″ has an exposed portion 128″ which is different in shape from the exposed portion 128 of the optical fiber 112. For example, in this embodiment, the exposed portion 128″ has enlarged diameter portions 180a and reduced diameter portions 180b alternately. An outer diameter of the enlarged diameter portions 180a is substantially the same as that of the clad 120. An outer diameter of the reduced diameter portions 180b is smaller than that of the enlarged diameter portions 180a. The outer diameters of the enlarged diameter portions may not be the same and also the outer diameters of the reduced diameter portions 180b may not be the same. The enlarged diameter portions 180a and the reduced diameter portions 180b are spaced away from each other while leaving a constant or any distance in the longitudinal direction therebetween by forming annular grooves (i.e., reduced diameter portions 180b) in the outer peripheral surface of the clad 120. The annular grooves may be formed by dipping the optical fiber in hydrofluoric acid to dissolve the glass-clad in part, which ensures smooth outer peripheral surfaces in the clad.

According to the optical fiber device 110″ and the optical fiber 112″, the laser beam transmitting in the clad 120 from the enlarged diameter portion 180a to the reduced diameter portion 180b is removed at the reducing boundary surface portion 180c connecting between the enlarged and reduced diameter portions 180a and 180b, depending on the reduction of the cross section. Since the plurality of enlarged and reduced diameter portions 180 are formed in the embodiment, the laser beam transmitting in the clad is reduced repeatedly and effectively. Also, no need to reduce the outer diameter of the clad so much, which ensures a certain strength required for the clad. Further, the tapered external surface of the clad is so smoothed that no substantial deterioration of strength occurs in the optical fiber. Furthermore, the enlarged and reduced diameter portions 180a and 180b are formed in a relatively easy way simply by reducing the diameter of the exposed portion 128″ of the clad at certain intervals, which allows the optical fiber, the optical fiber device, and the fiber laser device to be manufactured economically.

Although the optical fiber 112 has two clad layers in the above-described embodiments 7-9, it may have a single clad layer.

According to the embodiments 7-9, the optical power of the clad transmitting laser beam to be projected to the work is reduced. Consequently, the energy density of the beam emitted from the clad onto the machining point is reduced to equal to or less than 50 kW/cm², preferably equal to or less than 30 kW/cm², more preferably equal to or less than 15 kW/cm², which ensures a high quality smoothness with only minimum roughness Rz in the metal cutting surface cut by the laser emitted from the machining head.

It is noted that, in the above-described embodiments, significant advantages are obtained in particular when the laser oscillator is made of laser fiber because a relatively large amount of laser beam tends to be introduced into the clad in the oscillator and then delivered into the clad of the subsequent fiber.

1-17. (canceled)

18. A laser machining method using a laser machining apparatus, said apparatus including a laser oscillating section for oscillating a laser beam; a laser machining head; an optical fiber, including a core and a clad disposed around said clad, for transmitting said laser beam oscillated by the laser oscillating section into the laser machining head, said optical fiber cooperating with the laser machining head to form a beam transmitting section; and an assist gas supply for supplying an assist gas of oxygen to the laser machining head; wherein said laser beam is transmitted through said optical fiber and projected against a work to cut the work while supplying said assist gas to a cutting point of said work,
the method comprising:
removing or reducing said laser beam transmitting in said clad of said optical fiber or said laser beam projected from the clad so that an energy density of said laser beam transmitted from said clad and measured on said work is 15 kW/cm² or less.

19. The method of claim 18, wherein said laser oscillating section includes a fiber laser oscillator.

20. The method of claim 18,
wherein said laser oscillating section includes a plurality of laser oscillators;
wherein said beam transmitting section includes a plurality of first optical fibers having one ends each connected to said laser oscillators, and a second optical fiber having one end connected to said laser machining head and the other end connected to said one ends of the first optical fibers so that said laser beams oscillated by said laser oscillators are transmitted into the second optical fiber; and
wherein each of said first optical fibers and/or said second optical fiber includes said portion for removing or reducing said laser beam transmitting in said clad thereof.

21. The method of claim 20, wherein each of said laser oscillators includes a fiber laser oscillator.

22. The method of claim 18,
wherein said laser machining head includes an optical system for guiding said laser beam from said optical fiber toward a work to be machined, said optical system including an aperture plate for transmitting said laser beam projected from said core and cutting off said laser beam projected from said clad.

23. The method of claim 18, wherein said optical fiber includes a portion in which said clad is exposed, said exposed portion having an outer diameter which is continuously reduced toward a beam output port of said core and including a smoothed outer peripheral surface.

24. The method of claim 18, wherein said optical fiber includes a portion in which said clad is exposed, said exposed portion having an outer diameter which is reduced stepwise toward a beam output port of said core and including a smoothed outer peripheral surface.

25. The method of claim 18, wherein said optical fiber includes a portion in which said clad is exposed, said exposed portion having enlarged diameter portions and reduced diameter portion provided alternately and including a smoothed outer peripheral surface.

26. The method of claim 18, further comprising:
a first retainer for retaining a portion of said optical fiber, adjacent said beam output port,
a second retainer for retaining a jacket of said optical fiber, and
a cylinder for enclosing said optical fiber and holding said optical fiber through said first and second retainers.

27. The method of claim 18, wherein said work is made of material capable of being cut by heat provided from said laser beam.

28. The method of claim 26, wherein said material of said work is iron.

29. The method of claim 26, wherein said material of said work is mild steel.
